(19) United States
(12) Patent Application Publication
(10) Pub. No.: US 2008/0217374 A1
(43) Pub. Date: Sep. 11, 2008

(54) Device for installation of window covering brackets

(76) Inventor: Ramon Peacock, Douglas, GA (US)

Correspondence Address: BRIAN D. BELLAMY, P.O. BOX 1997, THOMASVILLE, GA, 31799-1997, US

(21) Appl. No.: 12/152,418

(22) Filed: May 14, 2008

Related U.S. Application Data
(62) Division of application No. 11/306,027, filed on Dec. 14, 2005, now abandoned.

(51) Int. Cl. B25C 5/10; B25C 7/00

(52) U.S. Cl. 227/147; 227/139

(57) ABSTRACT

An installation assembly for window blind brackets. The assembly has a housing holding a fastener device with washers or bushing on the fastener devices for support and to act as a washer upon installation. The same housing or an additional housing on the assembly holds a plunger device for punching the fastener device from the housing and into a mounting surface for installation of a bracket. Separate tabs or fill material within the housings may retain both the fastener device and plunger until use of the installation assembly. The installation assembly may be pre-arranged with a bracket and secured together until installation.

### PRIORITY CLAIM

The present application is a divisional application and claims benefit of the priority date U.S. patent application Ser. No. 11/306,027 filed on Dec. 14, 2005.

### BACKGROUND OF THE INVENTION

The field of the present invention is installation of window coverings and, more particularly, installation devices for attachment of window blinds via brackets and fasteners such as nails and staples.

A variety of mechanical methods have been developed for installation of window blinds and coverings. Some installation methods are complex and intended for use by professionals; other installation devices are too expensive to be packaged with typical consumer window blind products. Thus, a system of simple attachment accessories has been developed in the industry for inclusion with window blind packaging. The pieces are very inexpensive and basically comprised of brackets and screws in a small kit found within the larger packaging. The brackets are formed to each hold an end of the window-covering rail, and the brackets install onto the upper area on or about the window frame containing the window to be covered.

Despite the cheap and simple construction of these brackets, installing brackets for window blinds, curtain rods and other window accessories can be cumbersome and time consuming. Typically, the location for the bracket must be marked, the bracket held in place by hand, and a screw inserted and driven by hand. The screw, which operates as the fastener device for the bracket, must often be inserted in an awkward direction and requires laborious handling and turning of the screwdriver. Thus, a need exists for an improved system for installation of these brackets that does not significantly increase the cost of the kit or overall window covering package.

### SUMMARY OF THE INVENTION

An installation assembly is provided that resolves the unmet need for a simple and efficient device for faster installation of brackets like those that hold window blinds and other window coverings. The installation assembly provides a fastener device that is loaded into a housing or cylinder having an annular chamber that aligns the fastener device. In certain configurations the fastener device is pre-loaded and, in some cases, the fastener device is affixed in condition situated for alignment of the fastener device and installation thereof.

For instance, a nail and washers may be attached by plastic tabs, a fill material or other means centrally within a fastener housing that is configured to fit within a bracket and self-align the fastening device. A plunger device is situated within a secondary housing aligned with the fastener housing. The plunger provides a punch for impact by a hammer. Whereby, the plunger impacts the fastening device and drives the fastener through the bracket and into a mounting surface. Like the fastener device, the plunger may be prearranged and affixed within its respective housing. Acting in concert, the fastener housing aligns the fastening device with the bracket, the fastener is aligned within the housing, and the plunger is aligned with the fastener.

Therefore, an object of the present invention is to provide a device for fast and effective mounting of brackets for window blinds.

Another object of the present invention is to provide a device that coordinates the alignment of a bracket and fastening device for mounting of the bracket on a surface.

Another object of the invention is to provide a device that is effective in mounting a variety of different brackets for window coverings in various arrangements.

Yet another object of the invention is to provide a pre-arranged installation assembly with fastening device for mounting of brackets.

And yet another object of the invention is to provide a pre-packaged installation assembly combined with a bracket for mounting of the bracket.

### BRIEF DESCRIPTION OF THE DRAWINGS

FIG. 1a is a front plan view of a device constructed in accordance with the present invention and arranged for mounting a bracket to a wall surface.

FIG. 1b is a front plan view of the device of FIG. 1a shown after mounting the bracket to the wall surface.

FIG. 1c is a front plan view of the bracket of FIG. 1a and 1b attached to the wall surface by a fastener and bushing members driven against the bracket using the installation device.

FIG. 2 is a perspective view showing the fastener and bushing members of the device in additional detail.

FIG. 3 is an end plan view of a standard window blind bracket that may be mounted using the device of FIG. 1a through 1c.

FIG. 4a is a front plan view of a device constructed in an alternative embodiment having four fasteners comprised of nails and a pair of bushing members comprised of retaining washers and arranged for mounting a bracket to a wall surface.

FIG. 4b is a front plan view of the device of FIG. 4a shown after mounting the bracket to the wall surface.

FIG. 4c is a front plan view of the bracket of FIGS. 4a and 4b attached to the wall surface by a four fasteners comprised of nails and bushing member comprised of washers driven against the bracket using the device.

FIG. 5a is a perspective view showing an embodiment of the fasteners and bushing members of the installation assembly in additional detail.

FIG. 5b is a perspective view showing an alternative embodiment of the fasteners and bushing members in additional detail, wherein the fasteners comprise staples.

FIG. 6 is an end plan view of a standard window blind bracket that may be mounted using the installation assembly of FIG. 4a through 4c.

FIG. 7 is a front plan view of a device constructed in another alternative embodiment having breakaway retaining members for the fastener and means for securing the plunger within the device body.

FIG. 8 is a front plan view of an alternative embodiment of the invention in which the various parts are retained in predetermined order by a wrap material.

FIG. 9 is a front plan view of the device in an alternative embodiment in which the various parts are retained in predetermined order by a fill material.

FIG. 10 is a front plan view of the device in an alternative embodiment featuring a narrow cylindrical housing for loading or pre-loading a fastener device and bushing and further featuring a cylindrical plunger fitted within the same housing.

### DETAILED DESCRIPTION OF THE INVENTION

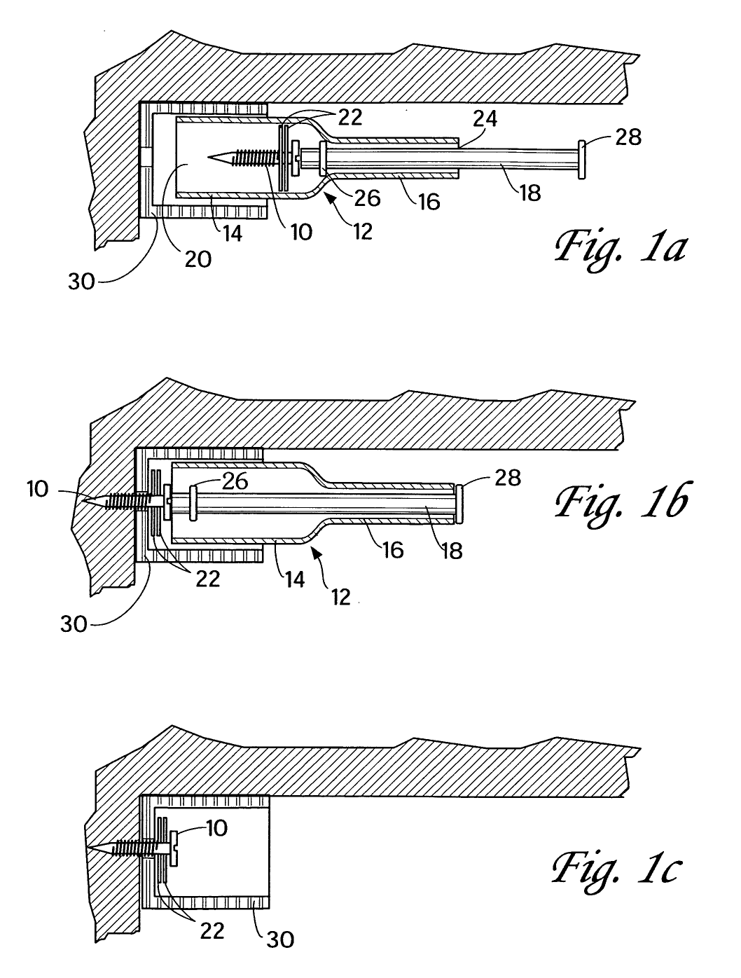

Referring to FIG. 1a in conjunction with FIG. 1b and 1c, the installation assembly or device for installation of brackets and window coverings includes a fastener device 10, a body 12 having a first housing 14 or fastener housing and a second housing 16 or plunger housing, and a plunger 18. The fastener device 10 securely loads into the fastener housing 14 for discharge through a first open 20 end of the body 12 by impact on the plunger 18. For example, in FIG. 1a, the fastener device 10 is loaded into the fastener housing 14 and aligned securely by plastic washers 22 that fill the inner circumference of the housing. The plunger 18 rests in an initial position with a first end abutting the head of the fastener device 10. The plunger housing 16 holds the plunger 18 in the initial position passing through a second open end 24 on the body 12 of the device. The plunger 18 slidably moves through the second open end 24 and the annular chamber of the body 12 upon impact, and the annular chamber guides the plunger against the faster device 10 once impact is made.

As shown in FIG. 1a, the plunger 18 may be secured and aligned within the plunger housing 16 by shoulders 26, 28 on each end thereof. The desire may be to secure the plunger 18 within the two housings 14, 16 of the installation assembly body 12. The shoulders or tabs 26, 28 are part of an exemplary embodiment disclosing a manner for controlling and securing the plunger 18. Flanges, channels, grooves and other housing and plunger structure can be provided to guide the plunger 18 within the body's annular chamber. In the example, a first shoulder or tabs 26, situated on the end of the plunger 18 lodged within the fastener housing 14, prevents the plunger from sliding completely out of the fastener housing in the upward direction. A second shoulder or set of tabs 28 situated on the end of the plunger 18 lodged within the plunger housing 16 prevents the plunger from sliding out of the plunger housing in the downward direction. Thus, the plunger 18 cannot be completely removed from the device. Such configuration prevents the plunger 18 from being removed and lost. Further, the shoulders 26, 28 may be configured in size and location to act as a guide for the plunger 18 to control both the distance that a fastener device 10 may be driven from the fastener housing 14 and the direction of the plunger 18.

Upon impact the fastener device 10 is driven outward from the fastener housing 14 as shown in FIG. 1b. The fastener device 10 is driven outward by impacting the plunger 18 with a hammer or other impact device to apply force. Thus, the plunger 18 functions as a punch device. The impact causes the plunger 18 to slide forward in the plunger housing 16 into the fastener housing 14 with great force and the first end of the plunger impacts the fastener device 10, which is guided by the fastener housing in combination with the plastic washers 22.

As shown in FIG. 1a and FIG. 1b, the fastener housing 14 is part of the unitary body 12 defining an annular chamber passing through the body. The fastener housing portion 14 of the body 12 may be designed to conform to the shape of the bracket 30 to be attached by the device. The combination of fastener device 10 and fastener housing 14 is designed to accommodate the specific type of bracket 30 that the installation device will be used to install. In the embodiment shown in FIGS. 1a through 1c, the combination is designed to attach a bracket 30 like those typically used in the installation of window blinds. The shown bracket 30 is cube shaped and open on two sides. The fastener housing 14 is sized and shaped to fit into the side of the bracket 30 and abut against the interior of the bracket. Each surface of the fastener housing 14 is flat and the housing is formed into a rectangular cross-section on at least three sides that fits inside the rectangular cross-section of a bracket 30. The fastener 10 is situated in the fastener housing 14 to align as needed with apertures in the bracket 30 where the fastener device should be inserted into a connecting surface such as window molding or wall. Thereby, a custom designed installation device will have a first housing 14 or fastening housing that fits snugly into a bracket 30 and self-align the fastener 10 with the brackets holes for attachment of the bracket.

The user will simply place the bracket 30 onto the end of the installation device about the fastener housing 14. The bracket 30 is placed against the connecting surface and installed with a single impact on the plunger 18. Referring to FIG. 1c, once the plunger 18 is impacted the fastener 10 will be driven from the fastener housing 14 and through the bracket 30 into the connecting surface. Thus, the bracket 30 is secured to the connecting surface very efficiently.

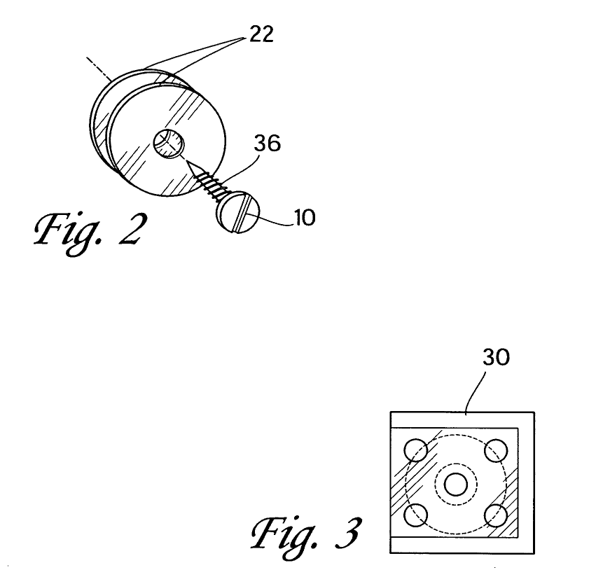

A very common window blind bracket 30 is shown in FIG. 3 in more detail. In a design of the installation device for use with the common bracket 30 of FIG. 3, a fastener device 10 may be used as shown in the FIGS. 1a-1c and FIG. 2 that comprises a single nail. The washers 22 shown in FIG. 2 perform the function of securing and aligning the fastener device 10 within the fastener housing 14 and also perform the function of assisting to secure the bracket 30 with a single nail.

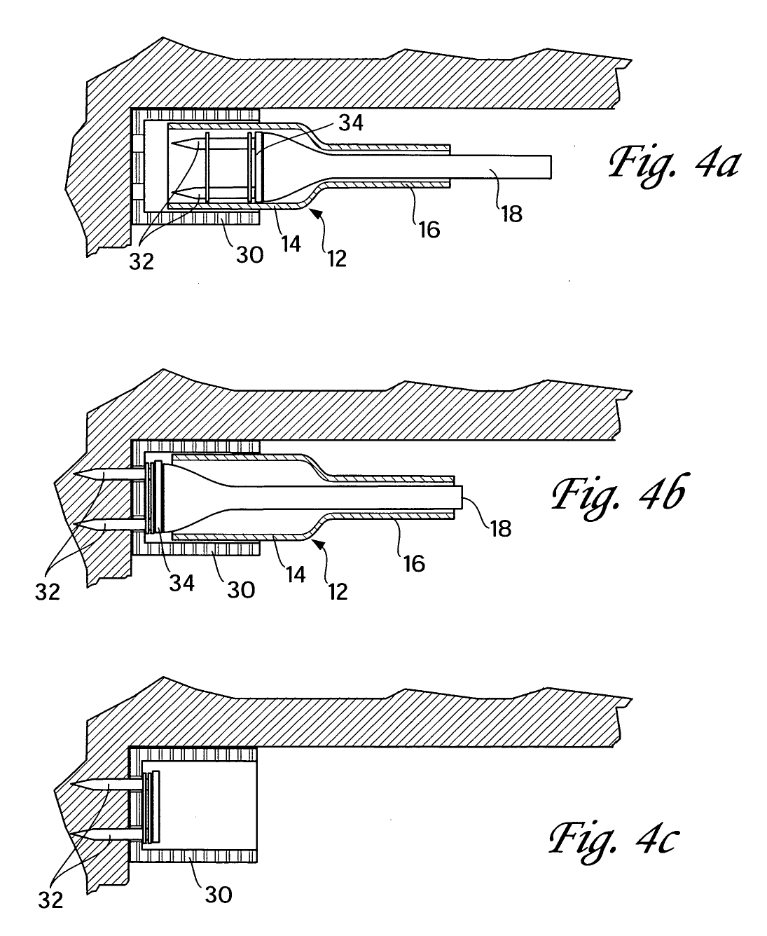

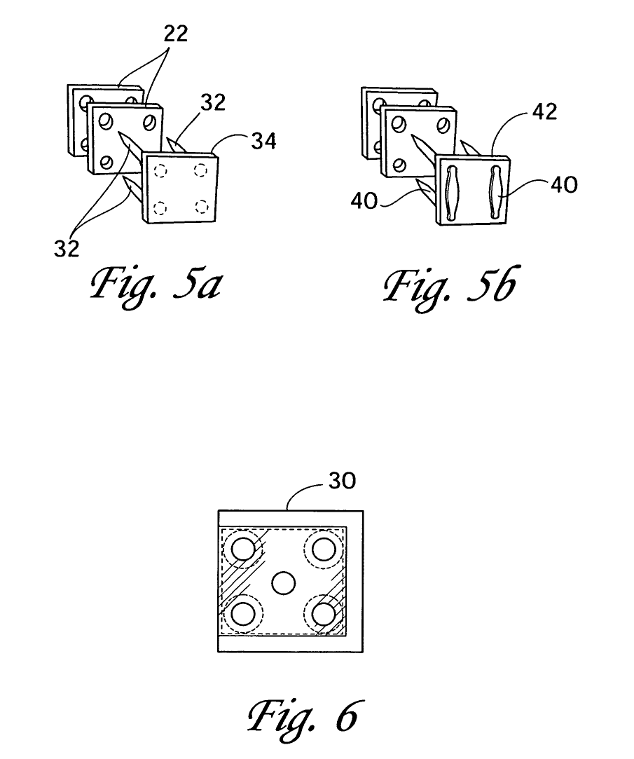

More complex designs are envisioned as shown in FIG. 4a in conjunction with FIG. 4b, FIG. 4c, FIG. 5 and FIG. 6. As shown in these figures, the fastener housing 14 may continue to be optimized in design to correctly fit a particular bracket 30. Furthermore, the fastener device 10 may be modified to include more than one nail. As depicted, four nails 32 in the fastener device are secured within the fastener housing. The plunger 18 continues to operate in cooperation with a second housing 16 or plunger housing, and one end of the plunger abuts the fastener device 10 to drive the fastener device from the fastener housing 14. The plunger end may be modified and widened or specially shaped to compliment the design of the fastener device 10. In this case, the wider plunger end abutting the fastener device will provide for uniform distribution of force at impact on the plunger 18. The self-aligning attributes of the fastener housing 14 in cooperation with the bracket 30 is especially advantageous in as show in FIG. 4b. All four nails 32 of the fastening device 10 are simultaneously driven through the bracket 30 into the connecting surface. The fastening device includes a washer 34 connecting the four nails 32. Upon completing of the fastening operation, the washer 34 provides additional security of the bracket mount and provides a clean and professional finish for the installation.

In FIGS. 1-6 the fastening device 10 is depicted in general as a nail or screw device. A preferred fastening device means would be a screw-type nail 36, as clearly shown in FIG. 2 and FIG. 7, with a tool engaging head 38 for tightening and removal. The screw-type nail 36 promotes penetration using less impact on the plunger 18, often only one stroke. The screw-type nail 36 also provides a secure attachment of a bracket 30 with only one appropriately sized nail. While the screw-type nail 36 provides a strong support for attaching a window covering bracket 30 and the advantages otherwise discussed, various other fastening devices could be used with the invention successfully.

FIG. 5b illustrates one variation on the design of the fastening device 10. Staple members 40 are attached to a washer member 42 that aligns the staples with the bracket 30 to be installed, and the washer member retains the staple members within the fastener housing 14. Like above, the washer 42 connecting and retaining the staple members 40 abuts the plunger 18. Upon execution of the plunger 18 to impact the washer 42, the staple members 40 affix the bracket 30 to a surface. The washer 42 provides a smooth, clean and professional finish with the washer covering the staples 40.

In an alternative embodiment, the fastening device 10 is secured within the fastener housing 14 by one or more plastic washers 44 that are initially attached to the interior surface of the fastener housing 14. The attached washers 44 retain the assembly parts together until the device is utilized. This feature is especially advantages for packaging and convenience of use. The plastic washers 44 may be made an integral part of the fastener housing 14 by the process of plastic molding. To allow for easy breakaway of the fastener device 10 from the housing 14, weak plastic tabs 46 may be formed as part of the washers 44. These tabs 46 remain connected to the interior of the housing 14 until impact. Upon impact on the fastening device 10, the tabs 46 connecting the plastic washers 44 break and the fastener and washers exit the fastener housing 14 to attach a bracket 30. The particular embodiment is especially beneficial for disposable applications of the invention, in that the device is packaged as whole assembly and throw away once broken by impact. FIG. 7 shows an exemplary embodiment of the tabbed design. As shown, plastic tabs 46 depend from one or more of the plastic washers 44 and attach to the body of the annular chamber.

The bracket 30 for installation may be incorporated into the assembly of the installation device. FIG. 7 illustrates a manner for combination of the bracket 30 with the installation assembly wherein the bracket is attached to the fastener housing 14 by plastic tabs 48 connected to the bracket and housing. These tabs 48 are like those used to attach the fastening device 10 to the housing 14 in the same embodiment shown in FIG. 7. Similarly, these tabs 48 connecting the bracket 30 are formed of weak plastic that will be easily broken upon activation of the plunger 18 to engage the fastening device 10. Once the fastening device 10 secures the bracket 30 to a surface, a twist of the installation device will remove the bracket 30 from the remainder of the device, leaving the installed bracket behind. The entire assembly may be molded of plastic with a fastening device 10. The plastic portion may be molded into one inexpensive installation device suitable for being discarded after a single use. Thus, each bracket 30 within a window covering installation kit in this configuration will include its own installation assembly as described herein.

Referring now to FIG. 8, another embodiment is shown in which the installation device is situated as initially shown in FIG. 1a, however modified by its packaging. In particular, the device is prepared for the initial installation of a bracket 30 by prearranging the bracket with regard to the fastening device 10 and plunger 18. The bracket 30 is situated on the fastener housing 14 so that the fastening device 10 may be installed through the bracket for installation of the bracket. Therefore, the situated bracket 30 and remaining installation device is shrink-wrapped or temporary bound together by packaging or other means. As shown, the parts are shrink-wrapped by plastic 50. Thereby, the installation device and bracket 30 may be provided as a convenient kit with the bracket prearranged for placement onto a surface and immediate installation by impacting the plunger 18. Upon attachment of the bracket 30 to a surface, the torn plastic wrap 50 is removed. This configuration does not require molding of tabs for attachment of the various parts, and this configuration may be reusable, while still providing convenience in packaging and initial use.

In yet another alternative embodiment shown in FIG. 9, the fastening device 10 is secured within the fastener housing 14 by fill material 52. The fill material 52 may comprise a material of such density as to retain the fastener device 10 while being weak enough to easily separate from the fastening device upon the employment of force on the plunger 18. Thus, the fill material 52 may generally comprise foam or melt plastic by filling the cavity of the fastener housing 14 with sufficient foam or plastic material that the fastening device 10 remains situated within the housing until impacted. The amount of foam or melt plastic is controlled to reduce mess and waste. Whereas, upon imparting force to the plunger 18, the foam or plastic will shear away and the fastening device 10 will exit the housing 14. In addition to holding the fastening device 10 within the fastener housing in this manner, the plunger 18 may likewise be secured within the fastener housing 14 and plunger housing 16 by a fill material 52. Like the above embodiment wherein the fastening device 10 is pre-attached to the fastener housing 14, using foam or melt plastic to secure the various parts of the fastener and plunger 18 into the various housings will provide for advantages where a disposable device is desired. These advantages include secure packaging without loose pieces that are easily misplaced or lost in packing. Further, the device will be easy to use because the various pieces are pre-aligned, securely held in place, and ready for impact to install a bracket 30.

In another embodiment, the fastener housing 14 has a raised shoulder on the interior of the housing that guides a nail and washer that may be provided separately.

In another embodiment, shown for example in FIGS. 7 and 9, shoulders 26, 28 on either end of the plunger 18 preserves the unit for driving a nail or screw and enable reuse of the device by reloading an additional fastening unit. A fastening unit may comprise fastener device 10, such as a nail or screw, contained within one or more bushing members, such as washers, that will fit within the cavity of the fastener housing.

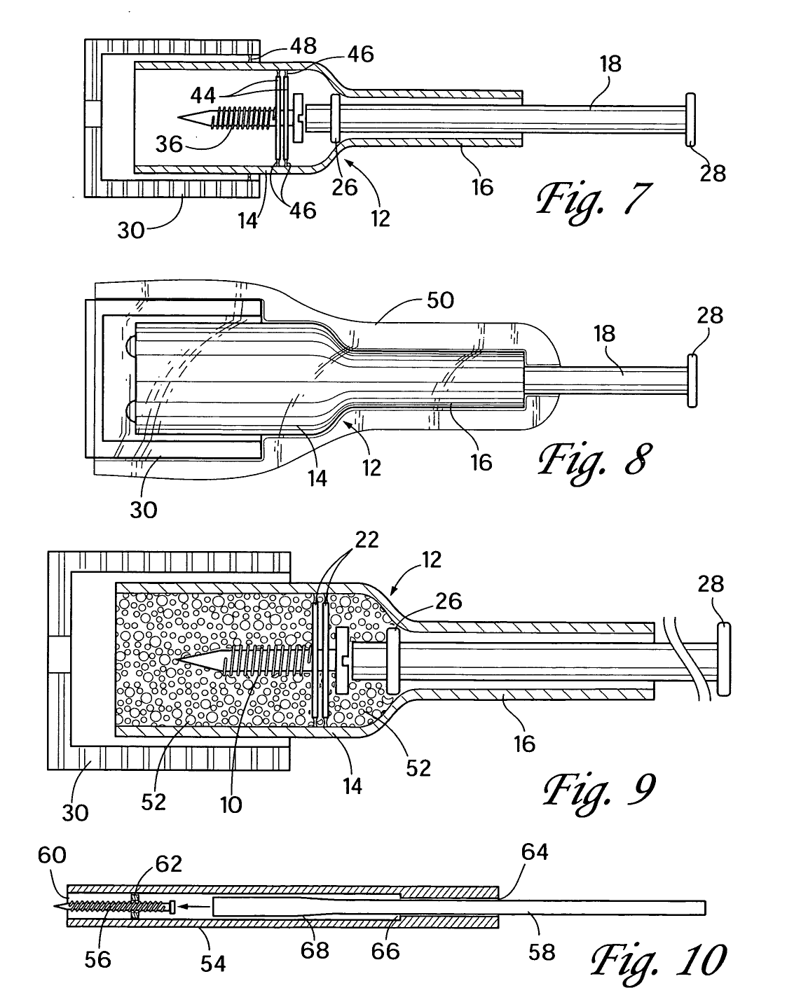

FIG. 10 shows a variation of the installation assembly that provides even greater flexibility for installation of a fastener device or a screw nail type fastener. The embodiment in FIG. 10 features a narrow and hollow cylinder 54 that could be constructed of metal to provide suitable strength. The cylinder 54 is constructed of a determined circumference for receiving a suitable fastener device 56 and a solid cylindrical plunger 58. A first portion 60 of the cylinder housing 54 may be loaded at the first end of the housing with a regular nail or screw-type nail as needed, or a fastening device may be pre-loaded into the housing. The embodiment shown illustrates the fastening device comprising a screw-type nail 56 bearing a bushing 62 thereabout and secured within the cylinder 54. The bushing 62 helps to secure the fastener 56 within the cylinder 54 and also functions as a washer upon installation of the fastener.

A second portion 64 of the hollow cylinder 54 has a narrowed or tapered portion 66 within the interior and has a slightly smaller diameter than the first portion 60 of the cylinder. The solid cylindrical plunger 58 that is fitted within the same hollow cylinder 54 slides therein. The plunger 58 will slide to bear against a fastener 56 that is loaded in the cylinder 54. The plunger 58 has an enlarged circumference 68 tapering or enlarged toward the end for bearing against the fastener. Upon retraction of the plunger 58 the enlarged portion 68 butts against the tapered interior 66 of the hollow cylinder 54. The tapered and enlarged portions of the cylinder and plunger prevent complete extraction of the plunger 58 in the direction opposing the loading end of the hollow cylinder 54.

The installation device of FIG. 10 operates by insertion of a nail-like fastening device 56, having a bushing 62, into the cylinder 54. Meanwhile, the plunger 58 remains installed within the cylinder 54. The plunger 58 is impacted and driven against the fastener 56 while the cylinder 54 guides the fastener and plunger. The hollow cylinder 54 may be used with greater flexibility than the previously discussed assembly by locating the device over any hole in the bracket 30 being mounted. Thus, the installation assembly of FIG. 10 is advantageous for use with brackets that are not standard or must be installed in a manner not conducive to the form fitting devices of FIGS. 1a and 4a.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention as defined by the claims.

What is claimed is:

1. A device for installation of a window-covering bracket comprising: a window-covering bracket in combination with a body having annular portions including a first housing portion and a second housing portion that are longitudinally aligned, a fastener device combined with a bushing member situated on the fastener device and the fastener device retained within the first housing portion, and a punch device situated and contained within the second housing portion in linear alignment with the fastener device, a second end of the punch device exposed outside of the annular chamber wherein the application of force thereto may be applied by a hammer striking the second end of the punch device and wherein with application of force the punch device is slidably movable in relation to the body in between a first position, in which the fastener device remains within the first housing portion, and a second position, in which the punch device is engaged through the first housing portion and the fastener device is installed into the window-covering bracket.

2. A device for installation of a window-covering bracket as in claim 1 in which the first housing portion includes at least three flat exterior surfaces that form at least three sides of a rectangular cross-section of the first housing portion for fitted insertion into the window-covering bracket.

3. A device for installation of a window-covering bracket as in claim 1 in which the window covering bracket is attached to the first housing portion until the window covering bracket is installed.

4. A device for installation of a window-covering bracket as in claim 1 in which the fastener device is retained within the first housing portion by plastic members appending from the bushing member and attaching to the body.

5. A device for installation of a window-covering bracket as in claim 1 in which plastic members appending from the punch device and attaching by connecting to the body and the punch device retain the punch device within the second housing portion.

6. A device for installation of a window-covering bracket as in claim 1 in which the punch device is secured within the body by a first shoulder member about a first end of the punch device situated within the first housing portion, and the first shoulder member shaped and sized to prevent sliding movement of the punch device beyond the second housing portion, and the punch device is secured within the unitary body by a second shoulder member about a second end of the punch device situated outside of the second housing portion, and the second should member shaped and sized to prevent sliding movement of the punch device beyond the second housing portion.
